(19) United States
(12) Patent Application Publication
(10) Pub. No.: US 2024/0369238 A1
(43) Pub. Date: Nov. 7, 2024

(54) AIR DRYER SYSTEM

(71) Applicants: Hyundai Motor Company, Seoul (KR); Kia Corporation, Seoul (KR)

(72) Inventors: Tae Soon Kim, Yongin-si (KR); Jae Soo Cha, Anyang-si (KR)

(21) Appl. No.: 18/488,363

(22) Filed: Oct. 17, 2023

(30) Foreign Application Priority Data
May 4, 2023 (KR) 10-2023-0058231

(51) Int. Cl. F24F 3/14

(52) U.S. Cl. CPC F24F 3/1411; F24F 2003/144

(57) ABSTRACT

An embodiment purge and non-purge adsorption type air dryer system includes a first adsorption tower and a second adsorption tower each including an adsorbent therein and configured to dehumidify compressed air flowing into an inside by using the adsorbent or regenerate the adsorbent by using outside air or the dehumidified compressed air, a plurality of pneumatic valves installed in a plurality of air passages connected to the first adsorption tower and the second adsorption tower, the plurality of pneumatic valves being configured to be opened and closed to change a flow path of each of the compressed air and the outside air, a blower configured to introduce the outside air into the first adsorption tower or the second adsorption tower, and a heater disposed at a rear end of the blower and configured to heat the outside air transferred from the blower.

### CROSS-REFERENCE TO RELATED APPLICATIONS

This application claims the benefit of Korean Patent Application No. 10-2023-0058231, filed on May 4, 2023, which application is hereby incorporated herein by reference.

### TECHNICAL FIELD

The present disclosure relates to an air dryer system.

### BACKGROUND

In general, an air compressor generates high-pressure air by sucking and compressing air in the atmosphere. The high-pressure air is used by being supplied to various facilities in a factory. Condensate is generated in a process of compressing air, and the generated condensate causes corrosion and failure of facilities. Therefore, a moisture remover is installed between an air compressor and an air tank. The existing water removal device is a purge type and consumes compressed air dehumidified during a regeneration process, and thus, uses more power for the air compressor.

A moisture remover (dehumidifier) removes moisture from the air to generate dry air and is also called an air dryer. An adsorption type dehumidifier passes compressed air through an adsorption tower filled with an adsorbent to remove moisture and produce dry air. As the compressed air discharged from a compressor or the like passes through a porous adsorbent inside the adsorption tower, a dehumidification process in which moisture in the compressed air is attached to pores of the adsorbent and removed is performed. When the adsorbent reaches a limit where it is difficult to adsorb moisture any more, a regeneration process in which regeneration air is supplied to the adsorbent to separate moisture from the adsorbent is performed in order to reuse the adsorbent.

The adsorption type dehumidifier usually has two adsorption towers with a built-in adsorbent. While the dehumidification process proceeds in one adsorption tower, the regeneration process proceeds in the other adsorption tower, and after a certain period of time, the dehumidification and regeneration processes in the two adsorption towers are switched to each other. The adsorption tower that has completed the regeneration process proceeds with the dehumidification process instead of the adsorption tower that has performed the dehumidification process, and the adsorption tower that has performed the dehumidification process proceeds with the regeneration process. The two adsorption towers take charge of the dehumidification and regeneration processes alternately, and dry air may be continuously produced.

The regeneration process of the adsorbent may be divided into a purge type and a non-purge type according to whether compressed air is consumed. In the purge type, the compressed air is used to regenerate the adsorption tower, and the compressed air is produced by operating a compressor or the like, and thus, the more compressed air is used in the regeneration process, the greater the energy consumption. In contrast, in the non-purge type, the compressed air is not used to regenerate the adsorption tower, which is advantageous for energy saving.

Therefore, in a dryer system, it is necessary to develop a solution to save energy by using the purge method and the non-purge method together for regeneration of the adsorbent.

### SUMMARY

The present disclosure relates to an air dryer system. Particular embodiments relate to an air dryer system that regenerates an adsorbent by using compressed air and external air in a process of dehumidifying the compressed air.

Embodiments of the present disclosure provide a purge and non-purge type adsorption air dryer system capable of adding a regeneration process of heating and cooling an adsorbent by introducing outside air from a blower, in addition to the existing regeneration process of the adsorbent by using compressed air.

An air dryer system according to an embodiment of the present disclosure, which is a purge and non-purge adsorption type air dryer system, includes a first adsorption tower and a second adsorption tower each including an adsorbent therein and dehumidifying compressed air flowing into an inside by using the adsorbent or regenerating the adsorbent by using outside air or the dehumidified compressed air, a plurality of pneumatic valves installed in a plurality of air passages connected to the first adsorption tower and the second adsorption tower and opened and closed to change a flow path of each of the compressed air and the outside air, a blower introducing outside air into the first adsorption tower or the second adsorption tower, and a heater disposed at a rear end of the blower and heating the outside air transferred from the blower.

The plurality of pneumatic valves may include a first pneumatic valve and a second pneumatic valve opened and closed so that the compressed air flows into the first adsorption tower or the second adsorption tower, a third pneumatic valve and a fourth pneumatic valve opened and closed so that the outside air flowing from the first adsorption tower or the second adsorption tower is discharged to the atmosphere, a fifth pneumatic valve and a sixth pneumatic valve opened and closed so that the outside air flows into the first adsorption tower or the second adsorption tower, a seventh pneumatic valve and an eighth pneumatic valve opened and closed so that the compressed air dehumidified in the first adsorption tower or the second adsorption tower is discharged to the outside, a ninth pneumatic valve and an eleventh pneumatic valve opened and closed so that the outside air transferred from the blower passes or does not pass through the heater, and a tenth pneumatic valve opened and closed so that the compressed air dehumidified in the first adsorption tower or the second adsorption tower is or is not recirculated to the first adsorption tower or the second adsorption tower.

A temperature/humidity converter detecting a state of the flowing outside air and transmitting state data to a control program may be installed at the front end of the blower.

A temperature sensor may be installed in an air passage through which the outside air passes through the third pneumatic valve and the fourth pneumatic valve and is discharged to the atmosphere.

When the first adsorption tower is used for dehumidifying the compressed air, the first pneumatic valve and the seventh pneumatic valve may be opened, and the second pneumatic valve, the third pneumatic valve, the fifth pneumatic valve, and the eighth pneumatic valve may be closed.

When the second adsorption tower is used for dehumidifying the compressed air, the second pneumatic valve and the eighth pneumatic valve may be opened, and the first pneumatic valve, the fourth pneumatic valve, the sixth pneumatic valve, and the seventh pneumatic valve may be closed.

When the second adsorption tower is used for regeneration of the adsorbent by the outside air, the sixth pneumatic valve and the fourth pneumatic valve may be opened, and the fifth pneumatic valve, the eighth pneumatic valve, the second pneumatic valve, and the third pneumatic valve may be closed.

When the second adsorption tower is used for regeneration of the adsorbent by heating by the outside air, the eleventh pneumatic valve may be opened, and the ninth pneumatic valve may be closed.

When the second adsorption tower is used for regeneration of the adsorbent by cooling by the outside air, the ninth pneumatic valve may be opened, and the eleventh pneumatic valve may be closed.

When the first adsorption tower is used for regeneration of the adsorbent by the outside air, the third pneumatic valve may be opened, and the first pneumatic valve and the fourth pneumatic valve may be closed.

When the first adsorption tower is used for regeneration of the adsorbent by heating by the outside air, the eleventh pneumatic valve may be opened, and the ninth pneumatic valve may be closed.

When the first adsorption tower is used for regeneration of the adsorbent by cooling by the outside air, the ninth pneumatic valve may be opened, and the eleventh pneumatic valve may be closed.

When the second adsorption tower is used for regeneration of the adsorbent by the compressed air, the tenth pneumatic valve, the sixth pneumatic valve, and the fourth pneumatic valve may be opened, and the ninth pneumatic valve, the eleventh pneumatic valve, the fifth pneumatic valve, the eighth pneumatic valve, the second pneumatic valve, and the third pneumatic valve may be closed.

When the first adsorption tower is used for regeneration of the adsorbent by the compressed air, the tenth pneumatic valve and the third pneumatic valve may be opened, and the first pneumatic valve and the fourth pneumatic valve may be closed.

The air dryer system according to an embodiment of the present disclosure may further include a regeneration cooler disposed in another air passage disposed in parallel with an air passage in which the heater is disposed at the rear end of the blower and cooling the outside air transferred from the blower, and a separator disposed at a rear end of the regeneration cooler and separating and removing moisture from the outside air.

A twelfth pneumatic valve allowing the outside air passing through the separator to flow into the first adsorption tower or the second adsorption tower may be further installed at a rear end of the separator.

According to embodiments of the present disclosure, in addition to the existing regeneration process of the adsorbent by using compressed air, the purge and non-purge adsorption type air dryer system uses the purge and non-purge types together in which a regeneration process of heating and cooling the adsorbent by introducing outside air from the blower is added, and thus, the adsorbent regeneration system capable of energy saving may be implemented.

In addition, the non-purge type regeneration structure is possible through a partial change of the outdoor air introduction structure without a major change in the existing purge type air dryer system structure, and thus, the manufacturing cost of the air dryer system may be reduced.

### BRIEF DESCRIPTION OF THE DRAWINGS

FIG. 1 is a diagram schematically showing an air dryer system according to an embodiment of the present disclosure.

FIG. 2 is a diagram illustrating a flow of compressed air during a dehumidification process in an air dryer system according to an embodiment of the present disclosure.

FIG. 3 is a diagram showing a flow of outside air during a non-purge type regeneration process by heating in an air dryer system according to an embodiment of the present disclosure.

FIG. 4 is a diagram showing a flow of outside air during a non-purge type regeneration process by cooling in an air dryer system according to an embodiment of the present disclosure.

FIG. 5 is a diagram showing a flow of dehumidified compressed air during a purge type regeneration process in an air dryer system according to an embodiment of the present disclosure.

FIG. 6 is a diagram showing an air dryer system in which a non-purge cooling pipe is omitted and the existing heating pipe is used according to another embodiment of the present disclosure.

FIG. 7 is a diagram showing an air dryer system further including a regeneration cooler and a separator in an air dryer system according to another embodiment of the present disclosure.

### DETAILED DESCRIPTION OF ILLUSTRATIVE EMBODIMENTS

Embodiments of the present disclosure will be described more fully hereinafter with reference to the accompanying drawings, so that those skilled in the art to which the present disclosure pertains may easily implement the embodiments of the present disclosure. However, embodiments of the present disclosure may be implemented in many different forms and are not limited to the embodiments described herein.

In addition, in various embodiments, elements having the same configuration are typically described in an embodiment by using the same reference numerals, and in other embodiments, only configurations different from the embodiment will be described.

Please note that the drawings are schematic and not drawn to scale. Relative dimensions and ratios of parts in the drawings are shown exaggerated or reduced in size for clarity and convenience in the drawings, and any dimensions are illustrative only and not limiting. In addition, the same reference numerals are used to denote similar features in the same structure, element, or parts appearing in two or more drawings. When an element is referred to as being “on” another element, it may be directly on the other element or intervening elements may also be accompanied.

The embodiments of the present disclosure specifically represent exemplary embodiments of the present disclosure. As a result, various modifications of diagrams are expected. Therefore, the embodiments are not limited to a specific shape of an area shown, and include, for example, a modification of the shape by manufacturing.

Hereinafter, an air dryer system according to embodiments of the present disclosure will be described in detail with reference to the drawings.

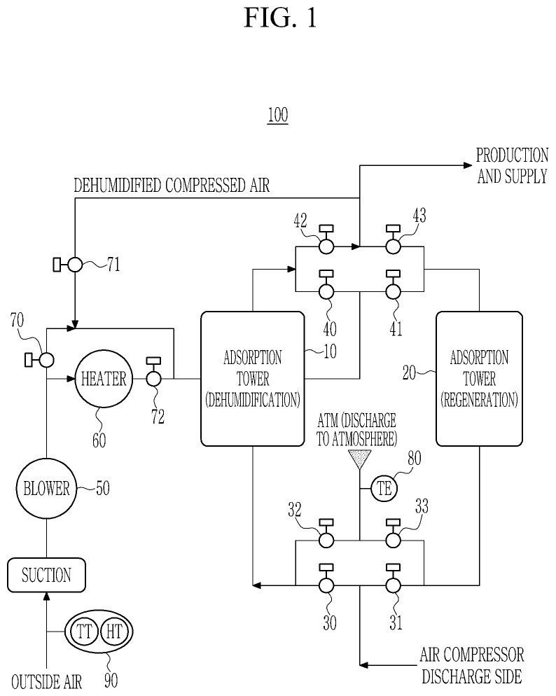

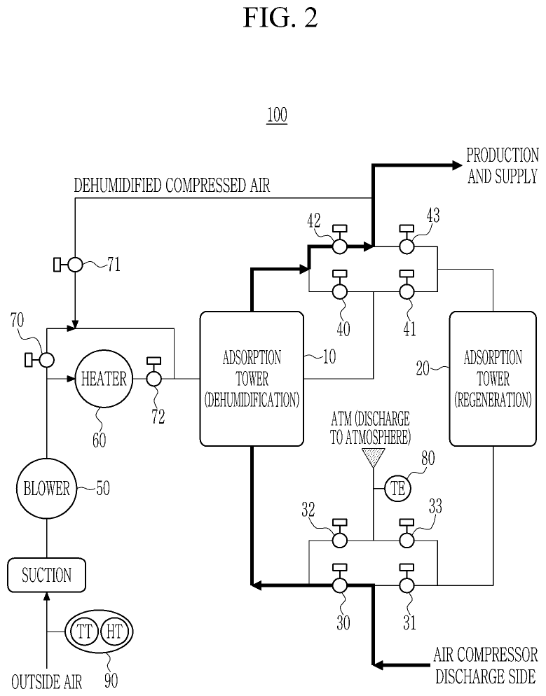

FIG. 1 is a diagram schematically showing an air dryer system according to an embodiment of the present disclosure. FIG. 2 is a diagram illustrating a flow of compressed air during a dehumidification process in an air dryer system according to an embodiment of the present disclosure.

Referring to FIGS. 1 and 2, an air dryer system 100 according to an embodiment of the present disclosure is a purge and non-purge adsorption type air dryer system and includes a first adsorption tower 10 including an adsorbent therein and a second adsorption tower 20. The first adsorption tower 10 and the second adsorption tower 20 dehumidify the compressed air introduced into the inside by using an adsorbent or regenerate the adsorbent by using outside air or the dehumidified compressed air.

Each of the first and second adsorption towers 10 and 20 is connected to a plurality of air passages so that the compressed air and the outside air flow in and out. In addition, an inlet through which the outside air and the compressed air may flow into the first and second adsorption towers 10 and 20 and an outlet through which the outside air and the compressed air may be discharged from the inside of the first and second adsorption towers 10 and 20 are formed in each of the first and second adsorption towers 10 and 20.

The adsorbent may be silica gel, activated alumina, or the like, which has a property of adsorbing moisture in the air.

The compressed air is produced from a device such as a compressor and is supplied to the first adsorption tower 10 and the second adsorption tower 20 through an air passage, and the outside air is supplied from the atmosphere by a blower 50 through the air passage to the first adsorption tower 10 and the second adsorption tower 20. The outside air supplied from the atmosphere may be transferred to the blower 50 through a suction, and an air filter (not shown) filtering out impurities in the air, a silencer (not shown) reducing noise caused by the air, etc. may be further installed at the front end of the blower 50.

A heater 60 heating the outside air transferred from the blower 50 may be installed at the rear end of the blower 50.

A plurality of pneumatic valves (two-way valves) 30 to 33, 40 to 43, and 70 to 73 that are opened and closed to change a flow path of the compressed air and the outside air may be installed in the air passage.

Referring to FIG. 1, the plurality of pneumatic valves 30 to 33, 40 to 43, and 70 to 72 may include first to eleventh pneumatic valves 30 to 33, 40 to 43, and 70 to 72. The first pneumatic valve 30 and the second pneumatic valve 31 may be opened and closed so that compressed air flowing from an air compressor discharge side flows into the first adsorption tower 10 or the second adsorption tower 20. The third pneumatic valve 32 and the fourth pneumatic valve 33 may be opened and closed so that outside air flowing from the first adsorption tower 10 or the second adsorption tower 20 is discharged to the atmosphere.

The fifth pneumatic valve 40 and the sixth pneumatic valve 41 may be opened and closed so that outside air supplied from the atmosphere flows into the first adsorption tower 10 or the second adsorption tower 20, and the seventh pneumatic valve 42 and the eighth pneumatic valve 43 may be opened and closed so that the compressed air dehumidified in the first adsorption tower 10 or the second adsorption tower 20 is discharged to the outside.

The ninth pneumatic valve 70 and the eleventh pneumatic valve 72 may be opened and closed so that outside air transferred from the blower 50 passes or does not pass through a heater 60, and the tenth pneumatic valve 71 may be opened and closed so that the compressed air dehumidified in the first adsorption tower 10 or the second adsorption tower 20 is or is not recirculated to the first adsorption tower 10 or the second adsorption tower 20.

Meanwhile, a temperature/humidity converter 90 detecting a state of the outside air flowing from the atmosphere and transmitting state data to a control program may be installed at the front end of the blower 50. The state of the outside air may be temperature, humidity, pressure, dew point, etc. of the outside air.

In addition, a temperature sensor 80 may be installed in the air passage through which the outside air passes through the third pneumatic valve 32 and the fourth pneumatic valve 33 and is discharged to the atmosphere. When the temperature of the air discharged to the atmosphere reaches a specific temperature, a non-purge regeneration by the outside air may be changed to a purge regeneration by the dehumidified compressed air by stopping the operation of the blower 50, closing the ninth pneumatic valve 70, and opening the tenth pneumatic valve 71. At this time, the specific temperature may be about 65° C. to about 75° C.

Referring to FIG. 2, in a dehumidification process using the first adsorption tower 10, the compressed air flows into the first adsorption tower 10 through the air passage. At this time, the first pneumatic valve 30 is opened, and the second pneumatic valve 31 and the third pneumatic valve 32 are closed. The compressed air is dehumidified by an adsorbent in the first adsorption tower 10, and the dehumidified compressed air is discharged to the outside and used for production and supply. At this time, the seventh pneumatic valve 42 is opened, and the fifth pneumatic valve 40 and the eighth pneumatic valve 43 are closed.

Meanwhile, although not shown, in a dehumidification process using the second adsorption tower 20, the compressed air flows into the second adsorption tower 20 through the air passage. At this time, the second pneumatic valve 31 is opened, and the first pneumatic valve 30 and the fourth pneumatic valve 33 are closed. The compressed air is dehumidified by an adsorbent in the second adsorption tower 20, and the dehumidified compressed air is discharged to the outside and used for production and supply. At this time, the eighth pneumatic valve 43 is opened, and the sixth pneumatic valve 41 and the seventh pneumatic valve 42 are closed.

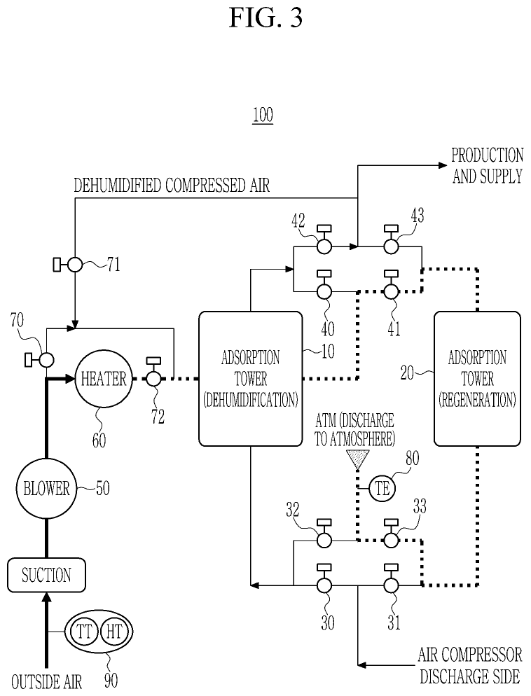

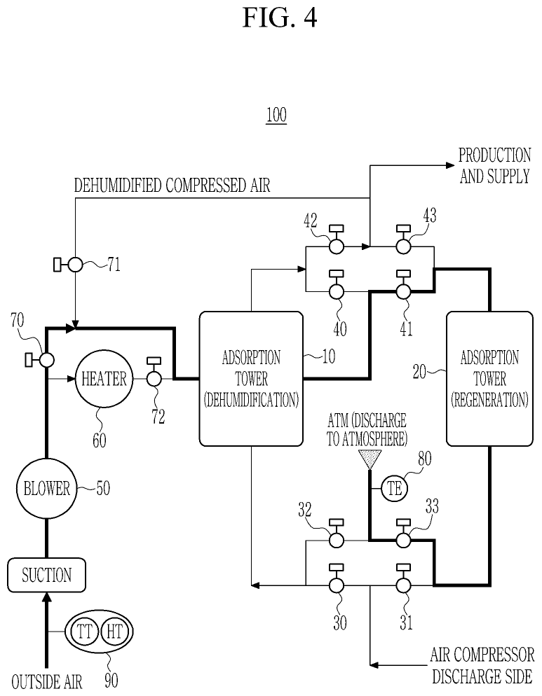

FIG. 3 is a diagram showing a flow of outside air during a non-purge type regeneration process by heating in an air dryer system according to an embodiment of the present disclosure. FIG. 4 is a diagram showing a flow of outside air during a non-purge type regeneration process by cooling in an air dryer system according to an embodiment of the present disclosure.

A non-purge type regeneration is a regeneration method using outside air in the atmosphere. In the non-purge type regeneration, the outside air may be transferred to the blower 50 through a suction, and an adsorbent may be regenerated in the first adsorption tower 10 or the second adsorption tower 20 in the blower 50.

Referring to FIG. 3, when regeneration is performed by the outside air by using the second adsorption tower 20, the sixth pneumatic valve 41 is opened, and the fifth pneumatic valve 40 and the eighth pneumatic valve 43 are closed. The outside air transferred from the blower 50 flows into the second adsorption tower 20 to regenerate the adsorbent, and the outside air flowing from the second adsorption tower 20 is discharged to the atmosphere. At this time, the fourth pneumatic valve 33 is opened, and the second pneumatic valve 31 and the third pneumatic valve 32 are closed.

Meanwhile, as shown in FIG. 3, in the regeneration process by heating, the outside air transferred from the blower 50 passes through the heater 60. At this time, the eleventh pneumatic valve 72 is opened and the ninth pneumatic valve 70 is closed.

As shown in FIG. 4, in the regeneration process by cooling, contrary to the above, the ninth pneumatic valve 70 is opened and the eleventh pneumatic valve 72 is closed.

On the other hand, although not shown, when regeneration is performed by the outside air by using the first adsorption tower 10, the outside air transferred from the blower 50 flows into the first adsorption tower 10 to regenerate the adsorbent, and the outside air flowing from the adsorption tower 10 is discharged to the atmosphere. At this time, the third pneumatic valve 32 is opened, and the first pneumatic valve 30 and the fourth pneumatic valve 33 are closed. Even at this time, a path of the outside air in the regeneration process by heating and the regeneration process by cooling is the same as a path during regeneration using the second adsorption tower 20.

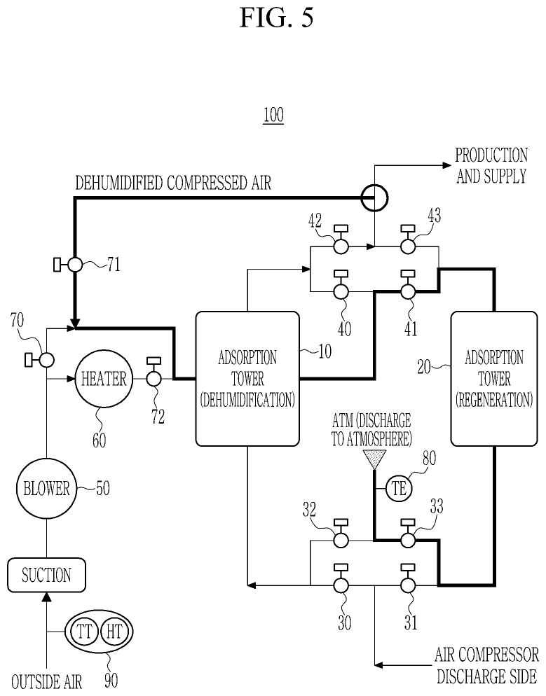

FIG. 5 is a diagram showing a flow of dehumidified compressed air during a purge type regeneration process in an air dryer system according to an embodiment of the present disclosure.

A purge type regeneration is a regeneration method using the dehumidified compressed air. In the purge type regeneration, compressed air is dehumidified in the first adsorption tower 10 or the second adsorption tower 20, and the dehumidified compressed air flows into the first adsorption tower 10 or the second adsorption tower 20 again, is recirculated, and is used for regeneration of an adsorbent.

Referring to FIG. 5, when the adsorbent is regenerated by using the compressed air dehumidified by using the second adsorption tower 20, the tenth pneumatic valve 71 is opened, and the ninth pneumatic valve 70 and the eleventh pneumatic valve 72 are closed. In this case, the compressed air is dehumidified by using the first adsorption tower 10. As described above, the compressed air is dehumidified in a state where the first pneumatic valve 30 is opened and the second pneumatic valve 31 and the third pneumatic valve 32 are closed, and in a state where the seventh pneumatic valve 42 is opened and the fifth pneumatic valve 40 and the eighth pneumatic valve 43 are closed.

The dehumidified compressed air is recirculated along the air passage in which the tenth pneumatic valve 71 is installed and flows into the second adsorption tower 20 and is used for regeneration before being used for production and supply. At this time, the sixth pneumatic valve 41 is opened and the fifth pneumatic valve 40 and the eighth pneumatic valve 43 are closed. The compressed air used for regeneration is discharged to the atmosphere. At this time, the fourth pneumatic valve 33 is opened and the second pneumatic valve 31 and the third pneumatic valve 32 are closed.

The purge and non-purge regeneration by cooling as shown in FIGS. 4 and 5 may be performed for about 1.4 hours to about 1.6 hours. When the temperature of the air sensed by a temperature sensor 80 is from about 65° C. to about 75° C., a cooling method may be switched from a non-purge type to a purge type.

Meanwhile, although not shown, when the adsorbent is regenerated by using the compressed air dehumidified by using the first adsorption tower 10, the tenth pneumatic valve 71 is opened, and the first pneumatic valve 30 and the fourth pneumatic valve 33 are closed. In this case, the compressed air is dehumidified by using the second adsorption tower 20. As described above, the compressed air is dehumidified in a state where the second pneumatic valve 31 is opened and the first pneumatic valve 30 and the fourth pneumatic valve 33 are closed, and in a state where the eighth pneumatic valve 43 is opened and the sixth pneumatic valve 41 and the seventh pneumatic valve 42 are closed.

The dehumidified compressed air is recirculated along the air passage in which the tenth pneumatic valve 71 is installed and flows into the first adsorption tower 10 and is used for regeneration before being discharged to the outside and used for production and supply.

The dehumidification process and the regeneration process described with reference to FIGS. 2 to 5 may be performed simultaneously. That is, when dehumidification is performed in one of the first adsorption tower 10 and the second adsorption tower 20, regeneration may be performed in the other adsorption tower. For example, the dehumidification and regeneration processes may be alternately performed about every 4 hours. Also, during the regeneration process, the cooling method may be changed according to the temperature of the air sensed by the temperature sensor 80. In addition, the operating time of the heater 60 may be set by a timer, and when the operating time elapses, the heater 60 and the blower 50 may be set to be automatically turned off.

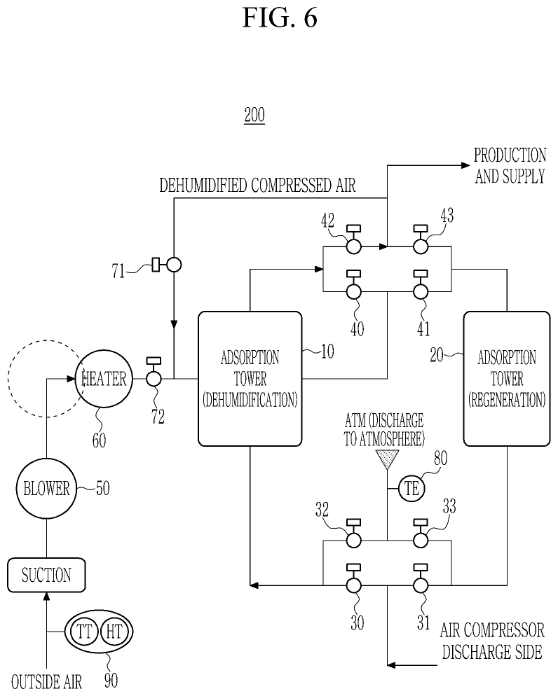

FIG. 6 is a diagram showing an air dryer system in which a non-purge cooling pipe is omitted and the existing heating pipe is used according to another embodiment of the present disclosure.

Referring to FIG. 6, a non-purge type regeneration using outside air may be configured such that the cooling pipe may be omitted and the outside air entirely passes through the heater 60. In other words, the existing heating piping may be used as it is without the non-purge cooling dedicated pipe.

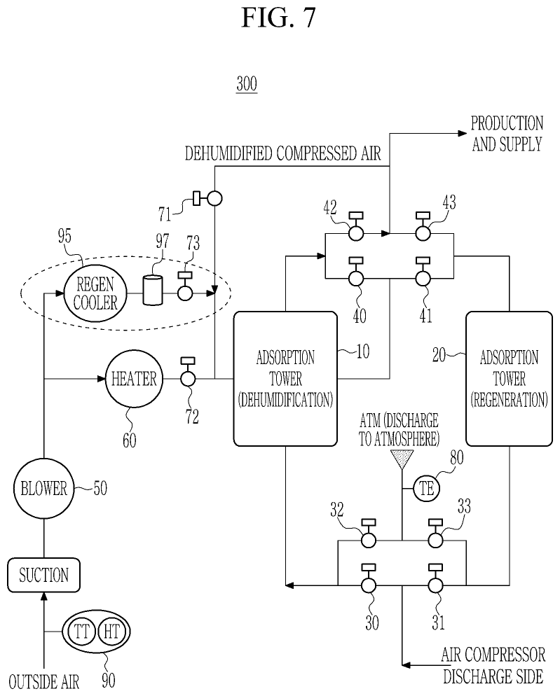

FIG. 7 is a diagram showing an air dryer system further including a regeneration cooler and a separator in an air dryer system according to another embodiment of the present disclosure.

Referring to FIG. 7, the air dryer system according to an embodiment of the present disclosure may further include a regeneration cooler 95 and a separator 97. The regeneration cooler 95 and the separator 97 may be disposed at the rear end of the blower 50 and may be disposed in another air passage disposed parallel to an air passage in which the heater 60 is disposed.

The regeneration cooler 95 may cool outside air transferred from the blower 50, and the separator 97 is disposed at the rear end of the regeneration cooler 95 to separate and remove moisture from the outside air passing through the regeneration cooler 95.

A twelfth pneumatic valve 73 that allows the outside air passing through the separator 97 to flow into the first adsorption tower 10 or the second adsorption tower 20 may be further installed at the rear end of the separator 97. The twelfth pneumatic valve 73 is closed so that the outside air may directly flow into the first adsorption tower 10 or the second adsorption tower 20, and the twelfth pneumatic valve 73 is opened so that the outside air may pass through the regeneration cooler 95 and the separator 97 to flow into the first adsorption tower 10 or the second adsorption tower 20.

As described above, according to embodiments of the present disclosure, in addition to the existing regeneration process of the adsorbent by using compressed air, the purge and non-purge adsorption type air dryer system uses the purge and non-purge types together in which a regeneration process of heating and cooling the adsorbent by introducing outside air from the blower is added, and thus, the adsorbent regeneration system capable of energy saving may be implemented.

In addition, the non-purge type regeneration structure is possible through a partial change of the outdoor air introduction structure without a major change in the existing purge type air dryer system structure, and thus, the manufacturing cost of the air dryer system may be reduced.

Although preferred embodiments of the present disclosure have been described above, the embodiments of the present disclosure are not limited to the above embodiments, and the embodiments of the present disclosure include all modifications within the range easily changed and recognized as being equivalent by those of ordinary skill in the art to which the present disclosure pertains from the embodiments of the present disclosure.

The following reference identifiers may be used in connection with the drawings to describe various features of the embodiments of the present disclosure.

| | |
|---|---|
| 100, 200, 300: air dryer system | |
| 10: first adsorption tower | 20: second adsorption tower |
| 30: first pneumatic valve | 31: second pneumatic valve |
| 32: third pneumatic valve | 33: fourth pneumatic valve |
| 40: fifth pneumatic valve | 41: sixth pneumatic valve |
| 42: seventh pneumatic valve | 43: eighth pneumatic valve |
| 70: ninth pneumatic valve | 71: tenth pneumatic valve |
| 72: eleventh pneumatic valve | 73: twelfth pneumatic valve |
| 50: blower | 60: heater |
| 80: temperature sensor | 90: temperature/humidity converter |
| 95: regeneration cooler | 97: separator |

What is claimed is:

1. A purge and non-purge adsorption type air dryer system comprising:
a first adsorption tower and a second adsorption tower each comprising an adsorbent therein and configured to dehumidify compressed air flowing into an inside by using the adsorbent or regenerate the adsorbent by using outside air or the dehumidified compressed air;
a plurality of pneumatic valves installed in a plurality of air passages connected to the first adsorption tower and the second adsorption tower, the plurality of pneumatic valves being configured to be opened and closed to change a flow path of each of the compressed air and the outside air;
a blower configured to introduce the outside air into the first adsorption tower or the second adsorption tower; and
a heater disposed at a rear end of the blower and configured to heat the outside air transferred from the blower.

2. The air dryer system of claim 1, further comprising a temperature/humidity converter disposed at a front end of the blower and configured to detect a state of the outside air and transmit state data to a control program.

3. The air dryer system of claim 1, wherein the plurality of pneumatic valves comprises:
a first pneumatic valve and a second pneumatic valve configured to be opened and closed so that the compressed air flows into the first adsorption tower or the second adsorption tower;
a third pneumatic valve and a fourth pneumatic valve configured to be opened and closed so that the outside air flowing from the first adsorption tower or the second adsorption tower is discharged to the atmosphere;
a fifth pneumatic valve and a sixth pneumatic valve configured to be opened and closed so that the outside air flows into the first adsorption tower or the second adsorption tower;
a seventh pneumatic valve and an eighth pneumatic valve configured to be opened and closed so that the compressed air dehumidified in the first adsorption tower or the second adsorption tower is discharged to the outside;
a ninth pneumatic valve and an eleventh pneumatic valve configured to be opened and closed so that the outside air transferred from the blower passes or does not pass through the heater; and
a tenth pneumatic valve configured to be opened and closed so that the compressed air dehumidified in the first adsorption tower or the second adsorption tower is or is not recirculated to the first adsorption tower or the second adsorption tower.

4. The air dryer system of claim 3, further comprising a temperature/humidity converter disposed at a front end of the blower and configured to detect a state of the outside air and transmit state data to a control program.

5. The air dryer system of claim 3, further comprising a temperature sensor disposed in an air passage through which the outside air passes through the third pneumatic valve and the fourth pneumatic valve and is discharged to the atmosphere.

6. The air dryer system of claim 3, wherein, in a state in which the first adsorption tower is used for dehumidifying the compressed air, the first pneumatic valve and the seventh pneumatic valve are opened and the second pneumatic valve, the third pneumatic valve, the fifth pneumatic valve, and the eighth pneumatic valve are closed.

7. The air dryer system of claim 3, wherein, in a state in which the second adsorption tower is used for dehumidifying the compressed air, the second pneumatic valve and the eighth pneumatic valve are opened and the first pneumatic valve, the fourth pneumatic valve, the sixth pneumatic valve, and the seventh pneumatic valve are closed.

8. The air dryer system of claim 3, wherein, in a state in which the second adsorption tower is used for regeneration of the adsorbent by the outside air, the sixth pneumatic valve and the fourth pneumatic valve are opened and the fifth pneumatic valve, the eighth pneumatic valve, the second pneumatic valve, and the third pneumatic valve are closed.

9. The air dryer system of claim 8, wherein, in a state in which the second adsorption tower is used for regeneration of the adsorbent by heating by the outside air, the eleventh pneumatic valve is opened and the ninth pneumatic valve is closed.

10. The air dryer system of claim 8, wherein, in a state in which the second adsorption tower is used for regeneration of the adsorbent by cooling by the outside air, the ninth pneumatic valve is opened and the eleventh pneumatic valve is closed.

11. The air dryer system of claim 3, wherein, in a state in which the first adsorption tower is used for regeneration of the adsorbent by the outside air, the third pneumatic valve is opened and the first pneumatic valve and the fourth pneumatic valve are closed.

12. The air dryer system of claim 11, wherein, in a state in which the first adsorption tower is used for regeneration of the adsorbent by heating by the outside air, the eleventh pneumatic valve is opened and the ninth pneumatic valve is closed.

13. The air dryer system of claim 11, wherein, in a state in which the first adsorption tower is used for regeneration of the adsorbent by cooling by the outside air, the ninth pneumatic valve is opened and the eleventh pneumatic valve is closed.

14. The air dryer system of claim 3, wherein, in a state in which the second adsorption tower is used for regeneration of the adsorbent by the compressed air, the tenth pneumatic valve, the sixth pneumatic valve, and the fourth pneumatic valve are opened and the ninth pneumatic valve, the eleventh pneumatic valve, the fifth pneumatic valve, the eighth pneumatic valve, the second pneumatic valve, and the third pneumatic valve are closed.

15. The air dryer system of claim 3, wherein, in a state in which the first adsorption tower is used for regeneration of the adsorbent by the compressed air, the tenth pneumatic valve and the third pneumatic valve are opened and the first pneumatic valve and the fourth pneumatic valve are closed.

16. A purge and non-purge adsorption type air dryer system, the air dryer system comprising:
a first adsorption tower and a second adsorption tower each comprising an adsorbent therein and configured to dehumidify compressed air flowing into an inside by using the adsorbent or regenerate the adsorbent by using outside air or the dehumidified compressed air;
a plurality of pneumatic valves installed in a plurality of air passages connected to the first adsorption tower and the second adsorption tower, the plurality of pneumatic valves being configured to be opened and closed to change a flow path of each of the compressed air and the outside air;
a blower configured to introduce the outside air into the first adsorption tower or the second adsorption tower;
a heater disposed at a rear end of the blower and configured to heat the outside air transferred from the blower;
a regeneration cooler disposed in a first air passage disposed in parallel with a second air passage in which the heater is disposed at the rear end of the blower, the regeneration cooler being configured to cool the outside air transferred from the blower; and
a separator disposed at a rear end of the regeneration cooler and configured to separate and remove moisture from the outside air.

17. The air dryer system of claim 16, further comprising a twelfth pneumatic valve installed at a rear end of the separator, the twelfth pneumatic valve being configured to allow the outside air passing through the separator to flow into the first adsorption tower or the second adsorption tower.

18. The air dryer system of claim 16, wherein the plurality of pneumatic valves comprises:
a first pneumatic valve and a second pneumatic valve configured to be opened and closed so that the compressed air flows into the first adsorption tower or the second adsorption tower;
a third pneumatic valve and a fourth pneumatic valve configured to be opened and closed so that the outside air flowing from the first adsorption tower or the second adsorption tower is discharged to the atmosphere;
a fifth pneumatic valve and a sixth pneumatic valve configured to be opened and closed so that the outside air flows into the first adsorption tower or the second adsorption tower;
a seventh pneumatic valve and an eighth pneumatic valve configured to be opened and closed so that the compressed air dehumidified in the first adsorption tower or the second adsorption tower is discharged to the outside;
a ninth pneumatic valve and an eleventh pneumatic valve configured to be opened and closed so that the outside air transferred from the blower passes or does not pass through the heater; and
a tenth pneumatic valve configured to be opened and closed so that the compressed air dehumidified in the first adsorption tower or the second adsorption tower is or is not recirculated to the first adsorption tower or the second adsorption tower.

19. The air dryer system of claim 18, further comprising:
a temperature/humidity converter disposed at a front end of the blower and configured to detect a state of the outside air and transmit state data to a control program; and
a temperature sensor disposed in a third air passage through which the outside air passes through the third pneumatic valve and the fourth pneumatic valve and is discharged to the atmosphere.

20. The air dryer system of claim 18, further comprising a twelfth pneumatic valve installed at a rear end of the separator, the twelfth pneumatic valve being configured to allow the outside air passing through the separator to flow into the first adsorption tower or the second adsorption tower.
